(19) United States
(12) Patent Application Publication
(10) Pub. No.: US 2025/0256137 A1
(43) Pub. Date: Aug. 14, 2025

(54) REACH REMOTE ELEVATED ANCHOR

(71) Applicant: Safewaze LLC, Concord, NC (US)

(72) Inventors: Clarke Jewell, Cornelius, NC (US); Cortland G. Schurian, Concord, NC (US)

(73) Assignee: Safewaze LLC, Concord, NC (US)

(21) Appl. No.: 19/039,482

(22) Filed: Jan. 28, 2025

Related U.S. Application Data
(60) Provisional application No. 63/551,927, filed on Feb. 9, 2024.

(51) Int. Cl. A62B 35/00; F16B 2/10

(52) U.S. Cl. CPC A62B 35/0068; F16B 2/10

(57) ABSTRACT

An apparatus and method of use for establishing a temporary overhead anchor that can be attached and detached to a variety of anchorage points. The temporary overhead anchor is intended to be used as an anchorage point for fall arrest equipment to be anchored to. The apparatus is designed to be securely attached to an anchorage point from ground level as to avoid the use of a ladder. The apparatus further includes a shuttle subassembly which allows for the transport of additional heavier fall arrest equipment from ground level to the elevated position via a rope and pulley system. Because this system includes a shuttle system and can be installed and removed from ground level, many of the shortcomings of other comparable systems are addressed with this disclosure.

### FIELD OF THE INVENTION

The present disclosure, in some embodiments, relates to apparatuses and methods for establishing a temporary overhead anchor and shuttle system. For example, the disclosure presents various embodiments of an apparatus for establishing a temporary overhead anchor and shuttle system from the ground level that can be used as an initial anchorage point to tether safety equipment such as self-retracting lanyards, as well as to shuttle additional safety equipment from the ground level to the temporary overhead anchor position. According to exemplary embodiments, the apparatus is designed to be attached to a variety of common elevated structural attachment points including, for example, I-beams and pipes, the features of which may also be utilized for attachment to other common anchorage points as well.

### BACKGROUND

There are many instances when it may be desirable to establish a temporary overheard anchor and shuttle system at an elevated structural attachment point. For example, OHSA regulations often require workers to use personal fall arrest or protection devices when working at elevations above 4-6 feet above the ground. These devices operate by quickly slowing the fall of a worker and preventing impact on the ground or objects below in the event of a fall or incident.

For these devices to safely prevent fall injuries, the worker will usually wear a harness that attaches to a safety cable. Typically, this safety cable is contained within a fall protection device, and is retractable so that it does not get in the way of the worker while performing their jobs at elevated heights. In order to be effective at stopping falls, the fall protection device must be anchored at a point generally above where the worker is performing their job. This way, the tension on the cable can counteract the downward motion of a falling worker.

As the fall protection device must support the full weight of a worker, the anchor point must be firmly established. In certain industries, such as in manufacturing plants, permanent anchor points may be built directly into the manufacturing areas when workers must regularly attach to the overheard anchor positions. In other instances, for example electrical repairman, no permanent anchor point is present. As such, these temporary fall protection systems must find a separate way to attach to a temporary anchorage point above the worker. These temporary anchorage points must be secure enough to support the weight of a worker, easily attachable and detachable, and able to attach to a variety of temporary anchorage points without causing damage.

A variety of temporary anchorage points are often available. For example, common temporary anchorage points include pipes, I-Beams, and D-Rings. Each of these points must be generally above the worker, and of sufficient strength to operate as an anchorage point, while still allowing for easy attachment and detachment.

Even assuming that a temporary anchorage point exists, workers must still find a way to safely attach and detach the fall protection devices to the temporary anchorage points. Typically this would entail the use of a ladder, however, this poses its own entire set of dangers associated with the use of ladders in the workplace.

As such, a need exists for a device and method of establishing a temporary overhead anchor and shuttle system from the ground level. The ideal apparatus and method will allow a worker to quickly and easily attach a temporary overhead anchor and shuttle system to an elevated structural attachment point for fall arrest equipment from the ground level without the need for ladders. Further, the device will allow for temporary, secure attachment to a variety of elevated structural attachment points. Lastly, the device will also allow a worker to establish a shuttle system to allow workers to safely transport additional safety materials from ground level to an elevated position.

### BRIEF SUMMARY OF THE INVENTIONS

Embodiments of the present disclosure addresses the problems presented above. In this regard, the present disclosure presents an exemplary device that can be used to establish a secure, temporary anchorage point to tether fall-protection safety equipment to from the ground level without the inherent risks involved with ladders or lifts.

Another exemplary use for the present disclosure is to establish a temporary overhead anchor and shuttle system for use in a personal fall arrest system (“PFAS”). This type of system allows workers to shuttle more permanent safety equipment such as heavy self-retracting lanyards and other safety equipment from the ground to an elevated position where it can be used for work. Typically, this type of system utilizes a pulley and rope setup, wherein the pulley is attached to a temporary anchorage point at the top, and ropes are used to raise and lower the safety equipment which is typically attached to one end of the rope. Many of the issues faced with the attachment of the fall protection devices are also shared with the attachment of the PFAS.

Accordingly, embodiments of the present disclosure includes an apparatus for establishing a temporary overhead anchor and shuttle system that can be attached and detached to a variety of elevated structural attachment points. The apparatus can be used to establish a shuttle system, that, in some embodiments, utilizes a ratcheting and locking claw mechanism, magnetic attachments, and a telescoping pole to securely attach to I-beams, pipes, D-rings, and other elevated structural attachment points from the ground level. More specifically, embodiments of the present invention allows a user to remotely attach the temporary overhead anchor to an elevated structural attachment point such that the temporary overhead anchor can be used to establish a connection point for fall arrest equipment, and simultaneously includes a shuttle system to allow a user to safely raise additional items such as self-retracting lanyards (“SRLS”), lifelines, and other PFAS materials to the temporary overheard anchor position. By using a scissor-like claw mechanism, the apparatus can be easily and securely attached to a variety of elevated structural attachment points. The use of a ratcheting and locking mechanism ensures the apparatus remains attached to the elevated structural attachment point under a variety of conditions. The use of an extendable pole allows the operator to safely attach the temporary overhead anchor to an elevated structural attachment point at a variety of heights, from the ground level. Finally, the use of the shuttle assembly allows the operator to safely raise and lower heavier fall arrest devices and other safety equipment between the ground level and the temporary overhead anchor position. This apparatus is designed for use in a variety of industrial or occupational uses, including construction, electrical, and tactical scenarios, and allows an operator to safely establish a temporary overhead anchor and shuttle system under a variety of conditions.

### BRIEF DESCRIPTION OF THE DRAWINGS

FIG. 1 illustrates a perspective view of an example of the presently disclosed temporary overhead anchor apparatus for establishing a temporary anchor point and shuttle system, according to one embodiment.

FIG. 2 illustrates an exploded view of an example of the presently disclosed temporary overhead anchor apparatus for establishing a temporary anchor point and shuttle system, according to one embodiment.

FIG. 3 illustrates a front view of an example of the presently disclosed temporary overhead anchor apparatus wherein the clamp subassembly is opened, according to one embodiment.

FIG. 4 illustrates a front view of an example of the presently disclosed temporary overhead anchor positioned onto an elevated structural attachment point, according to one embodiment.

FIG. 5 illustrates a perspective view of the clamp subassembly of the presently disclosed temporary overhead anchor apparatus, according to one embodiment.

FIG. 6 illustrates an exploded view of the ratcheting locking subassembly of the presently disclosed temporary overhead anchor apparatus, according to one embodiment.

FIG. 7 illustrates a perspective view of the shuttle subassembly of the presently disclosed temporary overhead anchor apparatus, according to one embodiment.

FIG. 8 illustrates an exploded view of the shuttle subassembly of the presently disclosed temporary overhead anchor apparatus, according to one embodiment.

FIG. 9 illustrates a perspective view of the pull cord for the shuttle subassembly of the presently disclosed temporary overhead anchor apparatus, according to one embodiment.

FIG. 10 illustrates a perspective view of the pulley and pulley housing for the shuttle subassembly of the presently disclosed temporary overhead anchor apparatus, according to one embodiment.

FIG. 11A illustrates a perspective view of the extendable pole subassembly with the threaded hook attachment, according to one embodiment.

FIG. 11B illustrates a perspective view of the extendable pole subassembly with the removable magnetic end, according to one embodiment.

FIG. 12 illustrates a perspective view of the extendable pole being inserted into the pole mount of the clamp subassembly attached to the stabilizing brace, according to one embodiment.

FIG. 13 illustrates an operator using the presently disclosed temporary overhead anchor apparatus to establish a temporary overhead anchor position, according to one embodiment.

FIG. 14. illustrates an operator using the extendable pole to release the shuttle from the temporary overhead anchor apparatus, according to one embodiment.

FIG. 15 illustrates an operator utilizing the temporary overhead anchor apparatus to raise additional fall arrest equipment to a temporary overhead anchor position, according to one embodiment.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising” when used in this specification, specify the presence of stated features, steps, orientations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the relevant art. It will be further understood that terms, such as those defined in commonly used dictionaries, should be interpreted as having a meaning that is consistent with their meaning in the context of the relevant art and the present disclosure and will not be interpreted in an idealized or overly formal sense, unless expressly so defined herein.

It will be understood that a number of techniques and steps relating to the disclosure are presented. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the inventions and the claims.

According to some embodiments, an apparatus for establishing a temporary overhead anchor and shuttle system is presented. In the following description, for purposes of explanation, numerous specific details are set forth in order to provide a thorough understanding of the present disclosure. It will be evident, however, to one skilled in the art that the present disclosure may be practiced without these specific details. The present disclosure is to be considered as one or more examples only and is not intended to limit the disclosure to the specific embodiments illustrated by the figures or description below.

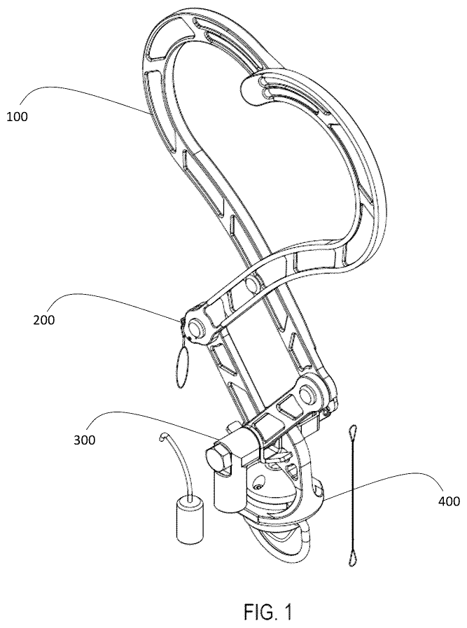

Referring now to FIG. 1, a perspective view of an apparatus for establishing a temporary overhead anchor and shuttle system is presented. In certain preferred embodiments, the apparatus contains a clamp subassembly 100, a ratcheting locking subassembly 200, a pole mount subassembly 300, and a shuttle subassembly 400. In some embodiments, the ratcheting locking subassembly 200 is attached laterally to the clamp subassembly 100, both of which are connected to and positioned above the shuttle subassembly 400, In certain embodiments, the pole mount subassembly 300 is attached directly to the clamp subassembly 100.

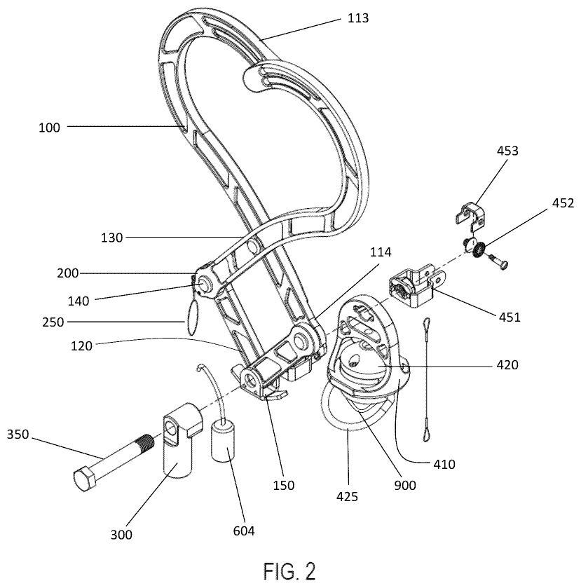

Referring to FIG. 2, an exploded view of the apparatus for establishing a temporary overhead anchor and shuttle system is shown. The clamp subassembly 100, the pole mount subassembly 300, and the shuttle subassembly 400 all are held together by a central assembly bolt 350, and all of the subassemblies combined together form the apparatus for establishing a temporary overhead anchor and shuttle system.

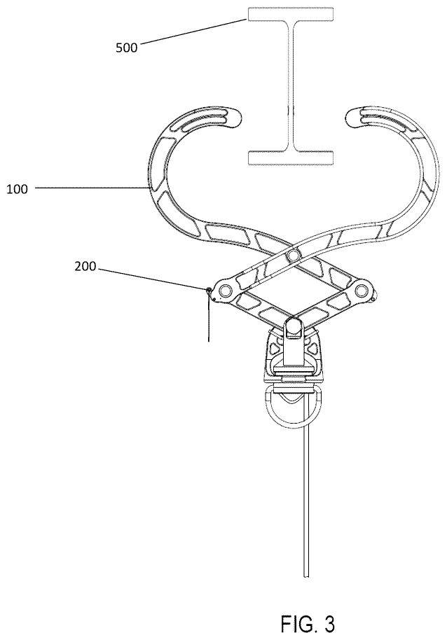

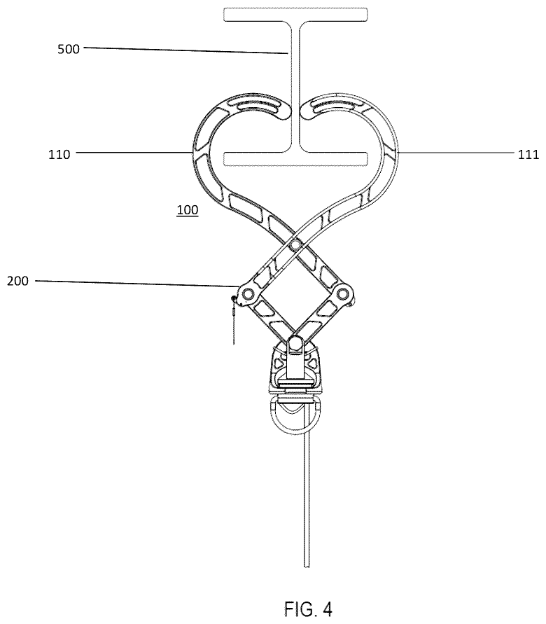

In certain embodiments, the presently disclosed apparatus is designed so that the clamp subassembly 100 can be opened, as shown in FIG. 3, and closed and positioned on an elevated structural attachment point 500 such as shown in FIG. 4. In the closed position, as shown in FIG. 4, the ratcheting locking subassembly 200 ensures that that the clamp subassembly 100 remains securely closed around the elevated structural attachment point 500 until released from the ground level by the operator.

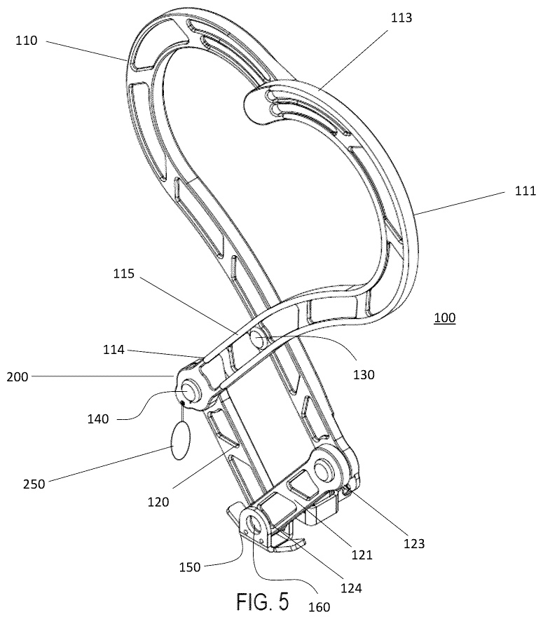

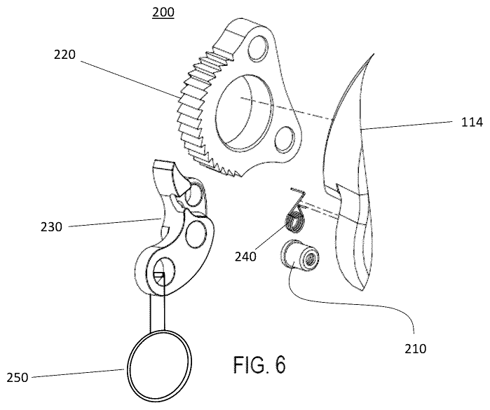

FIG. 5 shows a perspective view of the clamp subassembly 100 without any additional subassemblies attached. The clamp subassembly 100, in certain embodiments, is comprised of a first and second extension arm 110 and 111, wherein each of the first and second extension arms 110 and 111 include a hooked end 113, a straight end 114, and a midpoint 115. The clamp subassembly 100 further contains a first and second lower clamp arm 120 and 121, each of which include a lower clamp arm top end 123 and a lower clamp arm bottom end 124.

When fully assembled, the elements of the clamp subassembly 100 are arranged such that the hooked ends 113 of the first and second extension arms 110 and 111 face each other and the straight ends 114 of first and second extension arms 110 and 111 overlap each other at their midway points 115 such that the first and second extension arms 110 and 111 are substantially overlapped in an x-shaped formation.

In certain embodiments, a first rivet 130 is inserted through the midway point 115 of the first and second extension arms 110 and 111 in order to keep the first and second extension arms 110 and 111 pivotally connected.

Referring still to FIG. 5, the straight ends 114 of the first and second extension arms 110 and 111 are also arranged such that they each overlap the lower clamp arm top ends 123 of the lower clamp arms 120 and 121. Second rivets 140 are inserted to maintain a pivotal connection between the straight ends 114 of the first and second extension arms 110 and 111 and the lower clamp arm top ends 123 of lower clamp arms 120 and 121. The lower clamp arm bottom ends 124 of the lower clamp arms 120 and 121 are arranged such that they are substantially overlapped, and inserted into a stabilizing brace 150. In certain embodiments the lower clamp arms 120 and 121 are held pivotally in place within the stabilizing brace 150 by a third rivet 160.

In this arrangement, the first and second extension arms 110 and 111 are able to open and close in a scissor-like motion such that when in the open position, shown in FIG. 3, the first and second extension arms 110 and 111 are opened wide enough to surround an elevated structural attachment point 500, and when in the closed position, as shown in FIG. 4, the first and second extension arms 110 and 111 close tight enough to firmly grasp an elevated structural attachment point 500.

In order to ensure the first and second extension arms 110 and 111 remain securely attached to the elevated structural attachment point 500, the clamp subassembly 100 utilizes a ratcheting locking subassembly 200. As shown in FIG. 5, the ratcheting locking subassembly 200 attaches to both the flat end 114 of the second extension arm 111, and the lower clamp arm top end 123 of the first lower clamp arm 120. Without the ratcheting locking subassembly 200, the first extension arm 110 and the first lower clamp arm 120 freely pivot, which causes the hooked ends 113 of the first and second extension arms 110 and 111 to open and close. The ratcheting locking subassembly 200 allows a user to selectively lock this pivot action so that the hooked ends 113 cannot be opened without disengaging the ratcheting locking subassembly.

As shown in FIGS. 5 & 6, the ratcheting locking subassembly 200 is comprised of a ball nose detent 210, a drive gear 220, a pawl 230, and a release tab 250. In certain embodiments, the drive gear 220 attaches to the flat end 114 of the first extension arm 110, and the pawl 230 is attached to the lower clamp arm top end 123. A torsion spring 240 is interlaid in between the pawl 230 and the flat end 114 of the first extension arm 110. The torsion spring 240 ensures that the pawl 230 maintains a constant forward engagement with the drive gear 220. The constant forward engagement between the pawl 230 and the drive gear 220 prevents the first extension arm 110 and the first lower clamp arm 120 from pivoting. To disengage the ratcheting locking subassembly 200, a downward force is applied to release tab 250, which causes the pawl 230 to disengage from the drive gear 220, thereby allowing the first extension arm 110 and the first lower clamp arm 120 to freely pivot. Once the ratcheting locking subassembly 200 assembly is released, the first extension arm 110 and the first lower clamp arm 120 are free to pivot, and the first extension arm 110 and the second extension arm 111 can open in a scissor-like manner. This allows the clamp subassembly 100 to be removed from the elevated structural attachment point 500.

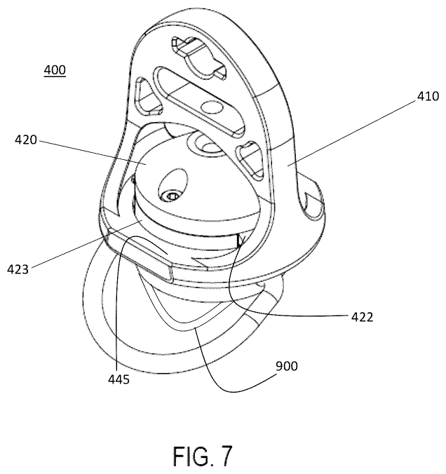

Another aspect of this apparatus is the shuttle subassembly 400, which is shown assembled in FIG. 7. The shuttle subassembly 400 includes at least a shuttle housing 410 and a shuttle 420. The entire shuttle subassembly 400 may be attached directly to the side of the stabilizing brace 150 of the clamp subassembly 100 via the central assembly bolt 350 as shown in

FIG. 2 by. The shuttle housing 410 may remain attached to the stabilizing brace 150 at all times, while the shuttle 420 is meant to be able to be detached from the shuttle housing 410 in order to be used as a shuttle device, according to some embodiments.

As shown in FIGS. 7 & 8, the shuttle 420 is comprised primarily of a top cap 421, one or more locking bars 422, a locking bar guide 423, a bottom cap 424, and a D-ring 425. The top cap 421 is the topmost portion of the shuttle 420. Beneath the top cap 421 is the locking bar guide 423 which contains one or more cutouts 430 which are sized and shaped to accommodate the one or more locking bars 422. Additionally, one or more compression springs 432 are located in between the one or more locking bars 422 and the locking bar guide 423. These compression springs 432 exert an outward force on the locking bars 422, ensuring the locking bars 422 remain outwardly extended from the locking bar guide 423 as far as the cutouts 430 of the locking bar guide 423 allow. The top cap 421 and the locking bar guide 423 are held together by one or more socket head bolts 433 with the one or more locking bars 422 and compression springs 432 maintained in between. The locking bar guide 423 is attached to the bottom cap 424 via one or more socket head bolts 433. Both the locking bar guide 423 and the bottom cap 424 include substantially u-shaped cutouts 435 which are sized and shaped to accept the D-Ring 425. In certain embodiments, the pull cord 900 is attached to the one or more locking bars 422, and runs from the locking bars 422 through the locking bar guide 423 and through an opening 436 in the bottom cap 424 such that a substantial portion of the pull cord 900 hangs below the shuttle 400 as shown in FIG. 7.

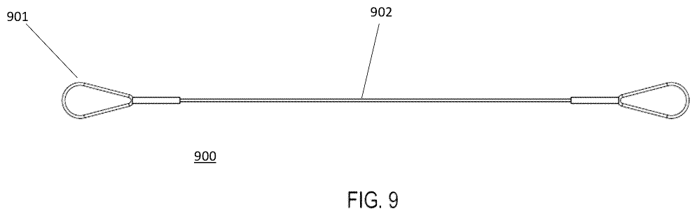

FIG. 9 provides an exemplary embodiment of the pull cord 900, which contains one or more looped ends 901 and a mid-section 902.

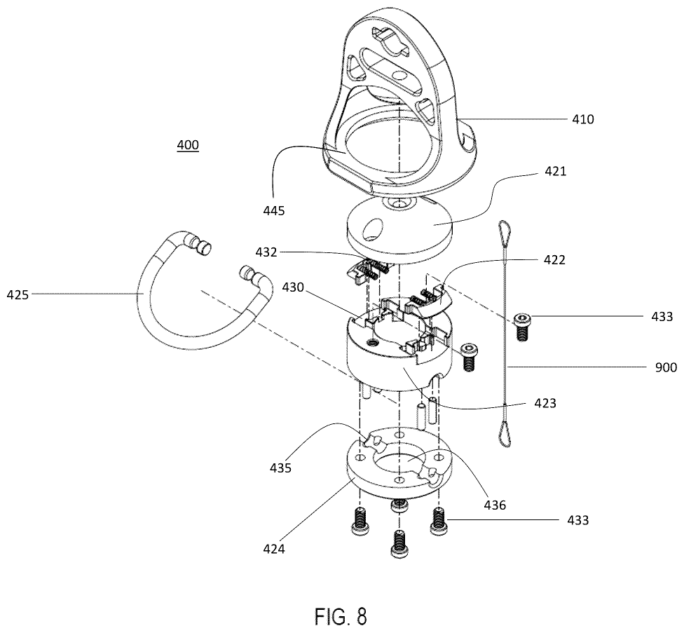

Referring back to FIGS. 7 and 8, the locking bars 422 extend outward from the locking bar guide 423 when the compression springs 432 exert an outward force on the locking bars 422. Also, each looped end 901 of the pull cord 900 is attached to one of the locking bars 422 in a manner such that the mid-section 902 of the pull cord 900 hangs below the shuttle 400 so that when the pull cord 900 is pulled downwardly with a force greater than the outward force of the compression springs 432, the locking bars 422 are retracted inward. It would be further recognized that the shuttle 420 is designed to be nestled into the shuttle housing 410 such that that locking bars 422, when extended, catch against the shuttle housing base 445. This contact is sufficient to lock the shuttle 420 in place within the shuttle housing 410. To release the shuttle 420 from the shuttle housing 410, an operator simply exerts a downward force on the pull cord 900 which causes the locking bars 422 to retract. Because the locking bars 422 are the means by which the shuttle 420 attaches to the shuttle assembly 410, once retracted, the shuttle 420 is free to be lowered to the ground.

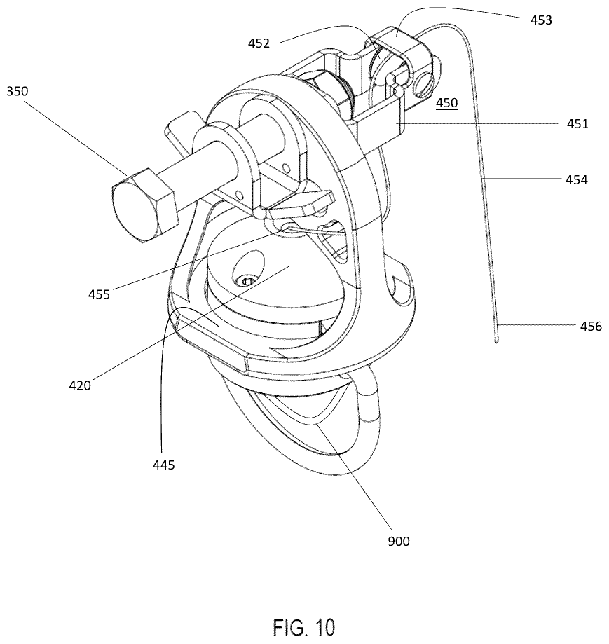

In order to allow the shuttle 420 to ascend and descend to the shuttle housing 410, a rope and pulley subassembly 450 as shown in FIG. 10 is employed. The rope and pulley subassembly 450 is comprised of a pulley mount 451, a pulley 452, a pulley loop 453, and a rope 454. The pulley mount 451 is attached directly to the shuttle housing 410 via the central assembly bolt 350 such the pulley 452 is situated substantially above the shuttle 420. The pulley loop 453 is attached to the pulley mount 451 and substantially encloses the pulley 452 to provide protection from damage to the pulley 452. The rope 454 has a first rope end 455, which is tied directly to the shuttle 420. The second rope end 456 is located on the other side of the pulley 452 and is sufficient length to hang down to the ground. The second rope end 456 is the end that allows operator to raise and lower the shuttle 420.

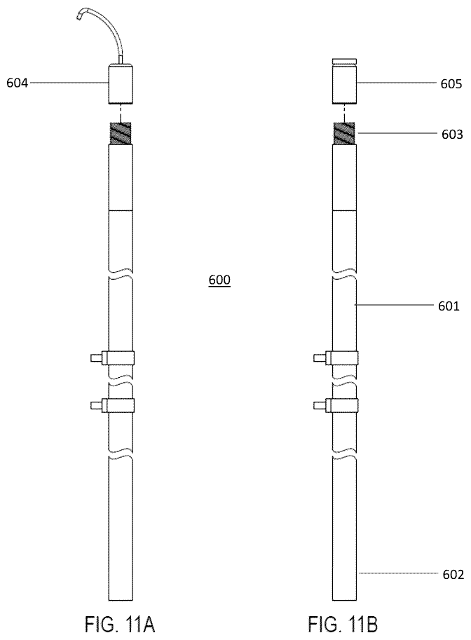

Because this remote anchor apparatus is designed to be attached to an elevated point 500 from the ground level, the disclosed apparatus utilizes an extendable pole subassembly 600 as shown in FIG. 11A & B. This extendable pole subassembly 600 is comprised of an extendable pole 601 including a first handle end 602 and a second threaded end 603. There are two interchangeable attachments that can be screwed onto the second threaded end 603 including a hook attachment 604 and a removeable magnetic end 605.

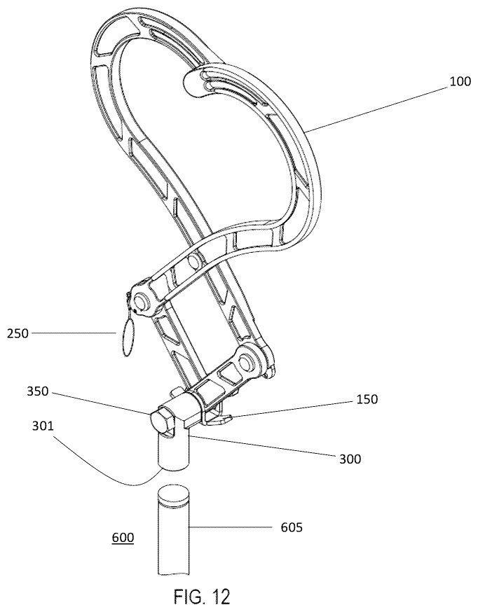

In order to raise and lower the presently disclosed remote anchor apparatus, there may be a simple and secure means for attaching the extendable pole subassembly 600 to the clamp subassembly 100. FIG. 12 shows how this is accomplished according to one embodiment. For example, the pole mount subassembly 300 is attached to the stabilizing brace 150 of the clamp subassembly 100 via the central assembly bolt 350. The pole mount subassembly 300 includes a substantially hollow and cylindrically shaped pole receiving end 301, and in certain embodiments this pole receiving end 301 may include internal magnets. The pole receiving end 301 is shaped and designed to accept the removable magnetic end 605 of the extendable pole subassembly 600.

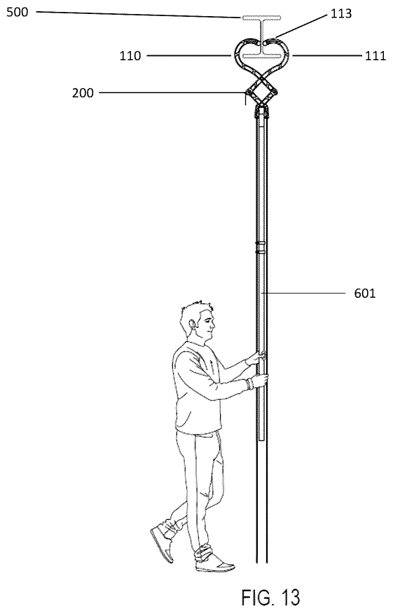

Referring now to the process of using the disclosed remote anchor apparatus, those skilled in the art will recognize that FIG. 13 represents one particular embodiment of using the remote anchor apparatus to establish a temporary overhead anchor position. Particularly, in order to establish a temporary overhead anchor position, an operator must first determine that a suitable elevated structural attachment point 500 exists. For the present remote anchor apparatus, this may include an I-beam, a D-ring, round stock, a pipe, and other similar points of contact.

As shown in FIGS. 11A and 11B, an operator may screw the removable magnetic end 605 onto the extendable pole 601. Then, as shown in FIG. 12, the operator inserts the removable magnetic end 605 into the pole receiving end 301. Once the threaded removable magnetic end 605 is inserted into the substantially hollow and cylindrically shaped pole receiving end 301, the threaded removable magnetic end 605 becomes magnetically attached to the pole mount subassembly 300. The next step is for the operator to ensure the clamp subassembly 100 is in a fully opened position as shown in FIG. 3. After the operator has confirmed that the clamp subassembly 100 is fully open, they must also ensure that the ratcheting locking subassembly 200 is engaged. This ensures that once the clamp subassembly 100 is closed around the elevated structural attachment point 500, as shown in FIG. 4, that it does not inadvertently open and cause the entire apparatus to fall.

Referring back to FIGS. 12-13, after ensuring that the ratcheting locking subassembly 200 is engaged, the operator can use the extendable pole 601 to hoist the remote anchor apparatus up to the structural attachment point 500. Once the apparatus reaches the elevated structural attachment point 500, the operator may utilize the extendable pole 601 to navigate the remote anchor apparatus so that at least one of the extension arms 110 or 111 contacts the elevated structural attachment point 500. As the operator pulls down the remote anchor apparatus, the hooked end 113 of the first extension arm 110 that is in contact with the elevated structural attachment point 500 causes the first extension arm 110 and the second extension arm 111 to close toward each other in a scissor-like motion. As the first extension arm 110 and the second extension arm 111 close into each other, the ratcheting locking subassembly 200 ensures that the first extension arm 110 and the second extension arm 111 are unable to be inadvertently released into the open position, due to the constant forward engagement between the pawl 230 and the drive gear 220 explained previously. After a certain amount of downward pressure is applied to the extendable pole 601, the first extension arm 110 and the second extension arm 111 will no longer be able to close any more. Once the apparatus is firmly connected to the elevated structural attachment point 500, all that is left to do is for the operator to continue to apply a downward pressure with the extendable pole 601 in order for the operator to separate the extendable pole's 601 removable magnetic end 605 from the pole mount subassembly 300.

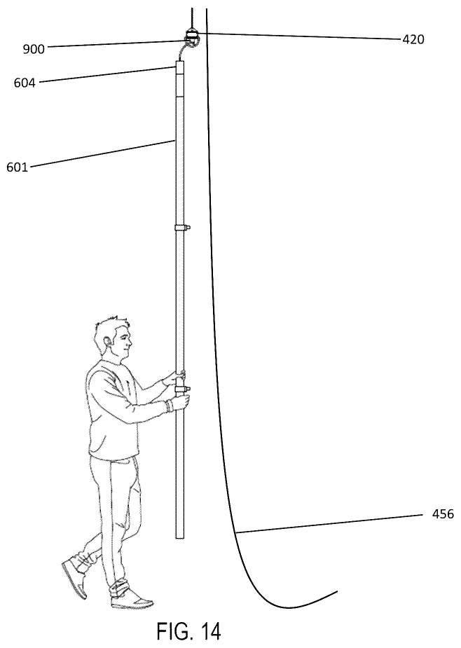

In order to use the shuttle system as intended, the operator must first release the shuttle 420 from the shuttle housing 410. Referring now to FIG. 14, according to one embodiment, an operator releases the shuttle 420 by using the extendable pole 601 with the hook attachment 604 to pull the pull cord 900. Once released, the operator can use the second rope end 456 to lower the shuttle 420 to ground level.

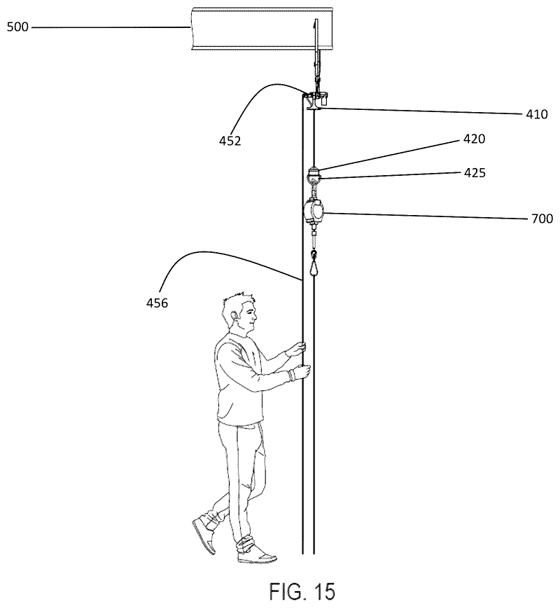

Turning now to FIG. 15, an exemplary use of the temporary overhead anchor and shuttle system is displayed. Additional fall arrest equipment 700 can be attached directly to the D-ring 425 located on the shuttle 420. This additional fall arrest equipment 700 could include harnesses, lifelines, SRLs, and other safety equipment allowing workers to securely attach themselves to the temporary overhead anchor position. This D-ring 420 is specifically designed to bear cargo weight, and allows for a variety of methods of attaching fall arrest equipment 700 to the shuttle 420. Once the fall arrest equipment 700 is securely attached to the shuttle 420, the ground operator may pull the second rope end 456, there by utilizing the pulley 452 to raise the shuttle 420 back to the shuttle housing 410.

Particularly, the remote anchor apparatus is intended to hoist fall arrest equipment 700, such as safety self-retracting lanyards, lifelines, and equipment from the ground level up to the temporary overhead anchor position. In order to facilitate the movement of fall arrest equipment 700 from the ground level the temporary overhead anchor position, the operator will use the second rope end 456 to raise and lower the fall arrest equipment 700. More particularly, the operator can raise and lower the shuttle 420 which is attached to the D-ring 425.

FIGS. 7 & 8 show how the shuttle 420 is able to re-engage with the shuttle assembly 400. Particularly, because of the top cap's 421 pointed shape, the shuttle 420 will be guided back into the shuttle housing 410 as it is raised. As shown in FIG. 8, the locking bars 422 have a substantially angled top surface, and as the shuttle 420 is pulled back into the shuttle housing 410, the angled top surface of the locking bars 422 contacts the shuttle housing base 445, and causes the locking bars 422 to be compressed inward so that the shuttle 420 may continue to be pulled upward into the shuttle housing 410. Turning back to FIG. 7, once the locking bars 422 clear the shuttle housing base 445, the locking bars 422 will expand beyond the shuttle housing 410 because of the outward force applied by the springs mentioned above, thereby locking the shuttle 420 into the shuttle housing 410 until later re-released by pulling the pull cord 900. Once the shuttle 420 is securely locked to the shuttle housing 410, operators can detach and reattach fall arrest equipment 700 as needed.

Removal of the temporary overhead anchor follows a similar process to its installation. Referring back to FIGS. 11A, 11B, 12, 13 & 14, once the work at the temporary overhead anchor position is completed, it may be desirable to remove the temporary overhead anchor. To do this, the ground operator must first ensure that there is no remaining fall arrest equipment 700 attached to the shuttle 420, and that the shuttle 420 is securely attached to the shuttle housing 410. To ensure that the shuttle 420 is firmly attached to the shuttle housing 410, the ground operator pulls the rope 454 firmly to fully raise the shuttle 420 into the shuttle housing 410 until the locking bars 422 expand beyond the shuttle housing 410. Once secured, the ground operator raises the extendable pole 601 with the hook attachment 604 up to the locking ratcheting subassembly 200, and utilizes the hook attachment 604 to pull the release tab 250 to disengage the ratcheting locking subassembly 200. Once the ratcheting locking subassembly 200 is released, the entire apparatus is free to be removed, but is no longer safe to use for its shuttling purpose. To finalize the removal, the ground operator swaps the hook attachment 604 with the removable magnetic end 605, and utilizes the extendable pole 601 to insert the removable magnetic end 605 into the pole mount assembly 300. Once the extendable pole 601 is firmly attached to the pole mount assembly 300, the ground operator can safely lower the entire assembly and collapse the extendable pole 601.

While various embodiments of the present disclosure have been described in detail, it should be apparent that modifications and variations thereto are possible, all of which fall within the true spirit and scope of the disclosure. For example, various other embodiments may not require all subassemblies to be present, or may include other similar subassemblies. One such example is that the shuttle housing may be attached directly to an elevated structural attachment point by other means than a clamp subassembly. Similarly, other embodiments may not utilize a pulley system but instead rely on electrical lift.

Additionally, various embodiments may utilize multiple of the same subassemblies. For example, certain embodiments may utilize two or more separate clamp subassemblies to increase the strength of the attachment point. Other embodiments may include multiple pulley systems to allow for simultaneous raising and lowering of multiple PFAS's.

Similarly, other embodiments may also include remote control options such as to remotely unlock the ratcheting locking subassembly, or to remotely raise and lower the shuttle subassembly without the need for the pulley subassembly.

Therefore, the foregoing is intended only to be illustrative of the principles of the disclosure. Further, since numerous modifications and changes will readily occur to those skilled in the art, it is not intended to limit the disclosure to the exact construction and operation shown and described. Accordingly, all suitable modifications and equivalents may be included and considered to fall within the scope of the disclosure, defined by the following claim or claims.

What is claimed is:

1. An apparatus for establishing a temporary overhead anchor, the apparatus comprising:
a clamp subassembly configured for attachment to an overhead anchor point, the clamp subassembly comprising a plurality of extension arms, wherein one or more of the extension arms are comprised of a locking subassembly;
a pole with an engagement end; and
a shuttle subassembly for attachment to the clamp subassembly and comprising a load lifting system and a detachable shuttle configured to raise and lower fall arrest equipment from a first level to the overhead anchor point,
wherein the apparatus is configured to be the temporary overhead anchor for the fall arrest equipment when the detachable shuttle is attached to the shuttle subassembly.

2. The apparatus of claim 1 wherein each of the plurality of extension arms is pivotally connected such that one or more of the plurality of the extension arms open and close in a clamp or scissor-like motion, and wherein the clamp subassembly is designed to be attached to the overhead anchor point comprising one of: a pipe, an I-beam, or a D-ring.

3. The apparatus of claim 1 wherein the locking subassembly comprises a ratcheting mechanism which in an unlocked configuration allows the plurality of extension arms to freely open and close relative to one another, and in a locked configuration allows the extension arms to close relative to one another but prevents the extension arms from opening relative to one another.

4. The apparatus of claim 1 wherein the locking subassembly comprises a release tab, and wherein the locking subassembly is biased by one or more biasing members into the locked configuration to prevent the plurality of extension arms of the clamp subassembly from opening outward until the release tab is pulled to disengage the biasing members to put the locking subassembly in the unlocked configuration.

5. The apparatus of claim 1 wherein the engagement end of the pole includes an interchangeable hook and magnetic end.

6. The apparatus of claim 1 wherein the clamp subassembly comprises a pole mount receiver for receiving the magnetic end of the pole.

7. The apparatus of claim 1 wherein the shuttle comprises one more outwardly-biased tabs which extend beyond one or more sides of the shuttle and a release cord being configured so that when a force is applied onto the release cord, the one or more outwardly-biased tabs are retracted into the shuttle subassembly.

8. The apparatus of claim 1 wherein the load lifting system further comprises a rope and pulley system.

9. A method of establishing and removing a temporary overhead anchor with a shuttle system, the method comprising:
forming the temporary overhead anchor for fall arrest equipment by engaging a locking mechanism on a clamp subassembly comprising a plurality of extension arms,
attaching the clamp subassembly to an overhead anchor point using a pole;
removing the pole from the clamp subassembly;
releasing a shuttle from a shuttle subassembly attached to the clamp subassembly;
lowering the shuttle from the shuttle subassembly using a load lifting system from the overhead anchor point;
attaching the fall arrest equipment to the shuttle;
raising the shuttle and attached fall arrest equipment back to the overhead anchor point;
engaging the shuttle into the shuttle subassembly using the load lift system so that the fall arrest equipment is established as a temporary overhead anchor;
removing the temporary overhead anchor by disengaging the shuttle from the shuttle subassembly and lowering the fall arrest equipment from the shuttle subassembly using the load lifting system;
disengaging the locking mechanism and removing the clamp subassembly from the overhead anchor point; and
lowering the clamp subassembly from the overheard anchor point.

10. The method of claim 9 wherein the plurality of extension arms of the clamp subassembly are fully spread apart, and the locking mechanism is engaged before the clamp subassembly is raised to the overheard anchor point.

11. The method of claim 9 wherein the clamp subassembly is raised to the overhead anchor point by attaching a pole with a magnetic end to a pole mount receiver on the clamp subassembly and raising the clamp subassembly using the pole.

12. The method of claim 9 wherein the clamp subassembly is engaged with the overheard anchor point by contacting one or more of the plurality of extension arms of the clamp subassembly against the overheard anchor point and applying a downward force with the pole to force the plurality of extension arms to close around the overheard anchor point, the locking mechanism preventing the plurality of extension arms from expanding relative to one another as they close, wherein the greater the downward force that is applied, the tighter the clamp subassembly locks to the overhead anchor point; and wherein once the clamp subassembly is securely attached to the overheard anchor point, the pole can be removed from the pole mount receiver by applying a downward force to separate the magnetic end of the pole from the pole mount receiver on the clamp subassembly.

13. The method of claim 9 wherein once the clamp subassembly is securely attached to the overheard anchor point, the magnetic end of the pole is replaced with a hook which is configured to disengage the shuttle from the shuttle subassembly by applying a force onto a cord attached to the shuttle which disengages the shuttle from the shuttle subassembly; and wherein the shuttle is lowered from the shuttle assembly using the load lifting system.

14. The method of claim 9 wherein once the shuttle subassembly is lowered using the load lifting system, one or more pieces of fall arrest equipment are attached to the shuttle; and wherein the shuttle and attached fall arrest equipment is raised to the overheard anchor point using the load lifting system.

15. The method of claim 9 wherein the operator applies a sufficient force to the load lifting system to securely reengage the shuttle into the shuttle subassembly at the overheard anchor point such that the fall arrest equipment is sufficiently secured for use as a temporary overhead anchor.

16. The method of claim 9 wherein upon completion of use of the fall arrest equipment as the temporary overhead anchor, the operator uses the pole with the hook to release the shuttle and attached fall arrest equipment from the shuttle subassembly, and lowers the shuttle and fall arrest equipment from the overheard anchor point using the load lifting system.

17. The method of claim 9 wherein upon removing the fall arrest equipment from the shuttle, the operator raises and reengages the shuttle back to the shuttle subassembly by applying a sufficient force onto the load lifting system.

18. The method of claim 9 wherein the operator uses the hook attachment of the pole to disengage the locking mechanism attached to one or more of the plurality of extension arms; thereby allowing the extension arms to open relative to one another.

19. The method of claim 9 wherein the operator replaces the hook on the pole with the magnetic end and uses the pole with the magnetic end to lower the clamp subassembly from the overheard anchor point.

20. A method of establishing a temporary overhead anchor comprising:
releasing a shuttle from a shuttle subassembly attached to an overhead anchor point;
lowering the shuttle from the shuttle subassembly using a load lifting system;
attaching fall arrest equipment to the shuttle;
raising the shuttle and attached fall arrest equipment back to the overhead anchor point; and
engaging the shuttle into the shuttle subassembly using the load lifting system so that the fall arrest equipment is established as a temporary overhead anchor.
